(19) United States
(12) Patent Application Publication
(10) Pub. No.: US 2026/0300091 A1
(43) Pub. Date: Oct. 1, 2026

(54) ESTIMATING FAILED BIT COUNT

(71) Applicant: SK hynix Inc., Gyeonggi-do (KR)

(72) Inventors: Fan Zhang, Fremont, CA (US); Pengfei Huang, San Jose, CA (US)

(21) Appl. No.: 19/095,037

(22) Filed: Mar. 31, 2025

(51) Int. Cl. G06F 11/10

(52) U.S. Cl. CPC G06F 11/106; G06F 11/1004; G06F 11/1068

(57) ABSTRACT

Techniques for determining failed bit count (FBC) estimation of a codeword are described. A read operation on a memory can be performed to obtain a codeword. Error decoding on the codeword may be performed with an error decoder to generate an initial checksum. It may be determined that the initial checksum of the codeword exceeds a checksum saturation threshold corresponding to an error correction capability of the error decoder. An FBC estimation of the codeword may be determined based on a dataset containing correlations between decoding information and a set of FBCs. The dataset may be obtained by, for each FBC in the set of FBCs, injecting the FBC number of errors into a training codeword, performing a plurality of decoding iterations on the training codeword using the error decoder, and recording, in the dataset, the decoding information for each decoding iteration.

### BACKGROUND

Error-correction codes (ECCs) are frequently used for various types of data storage devices such as NAND flash memories. ECCs are also frequently used during the process of data transmission. ECC refers to codes that add redundant data, or parity data, to a message, such that the message can be recovered by a receiver equipped with a decoder even when one or more errors were introduced, either during the process of transmission, or storage. In general, an ECC decoder can correct a limited number of errors (e.g., failed bits), with the number depending on the type of code used and/or the error correction capability of the decoder itself. In some examples, when the decoder fails to decode, e.g., the number of errors is higher than the error correction capability of the decoder, checksum can be used to estimate a failed bit count (FBC).

### BRIEF SUMMARY

Techniques for determining FBC estimation of a codeword are described. A read operation on a memory can be performed to obtain a codeword. Error decoding on the codeword may be performed with an error decoder to generate an initial checksum. The error decoder can be a low-density parity check (LDPC) decoder. It may be determined that the initial checksum of the codeword exceeds a checksum saturation threshold corresponding to an error correction capability of the error decoder. A failed bit count (FBC) estimation of the codeword may be determined based on a dataset containing correlations between decoding information and a set of FBCs. The dataset may be obtained by, for each FBC in the set of FBCs, injecting the FBC number of errors into a training codeword, performing a plurality of decoding iterations on the training codeword using the error decoder, and recording, in the dataset, the decoding information for each decoding iteration. A corrective action may be performed on the memory based on the FBC estimation. In some implementation, the techniques for FBC estimation can be performed by a device having a memory that stores data using LDPC codewords. The device can be a solid-state storage device, and the memory can be implemented using flash memory. The FBC estimation can be performed by a memory controller. The memory controller may include one or more processors executing software such as firmware implementing the FBC estimation algorithm.

In some implementations, the decoding information may include, for each decoding iteration performed on the training codeword, a total number of bits flipped by the error decoder from an initial decoding iteration.

In some implementations, the decoding information may include a checksum computed for each decoding iteration performed on the training codeword.

In some implementations, the decoding information may include, for each decoding iteration performed on the training codeword, a total number of bits flipped by the error decoder from an initial decoding iteration and a checksum computed for the decoding iteration.

In some implementations, determining the FBC estimation may include identifying a decoding iteration from the plurality of decoding iterations at which the decoding information saturates, and using the identified decoding iteration of the codeword to determine the FBC estimation of the codeword.

In some implementations, determining the FBC estimation may include providing decoding information of the codeword to a neural network model trained with the dataset to obtain the FBC estimation.

In some implementations, a second memory read operation may be performed to obtain a second codeword, and error decoding on the second codeword may be performed with the error decoder to generate a second initial checksum. It may be determined that the second initial checksum of the second codeword is at or below the checksum saturation threshold, and a FBC of the second codeword may be estimated using the second initial checksum.

### BRIEF DESCRIPTION OF THE DRAWINGS

The detailed description below makes reference to a few example embodiments that are illustrated in the accompanying drawings. However, it should be understood that the description is equally relevant to various other variations of the embodiments described herein. Such embodiments may utilize objects and/or components other than those illustrated in the drawings. It should also be understood that like reference numerals used in the various figures indicate similar or identical objects.

FIG. 1 illustrates an example graph between a checksum (CS) and a failed bit count (FBC) for a typical low-density parity check (LDPC) decoder.

FIG. 2 illustrates a block diagram of an example error correction system that can be used to perform error decoding and correction.

FIGS. 3A and 3B illustrate an example parity-check matrix and an example graph representing the parity-check matrix.

FIG. 4 illustrates an example error correction system that can be used for FBC estimation, in accordance with certain embodiments of the present disclosure.

FIG. 5 illustrates an example graph showing correlations between a total number of bits flipped and a set of FBCs for a plurality of decoding iterations, in some aspects of the disclosure.

FIG. 6 illustrates an example graph showing correlations between a checksum and a set of FBCs for a plurality of decoding iterations, in some aspects of the disclosure.

FIG. 7 illustrates an example neural network configured as an FBC estimator in accordance with an embodiment of the disclosure.

FIG. 8 illustrates a flow diagram of an example of a process for generating a dataset to be used for FBC estimation in certain aspects of the disclosure.

FIG. 9 illustrates a flow diagram of an example of a process for determining an FBC estimation, in certain aspects of the disclosure.

FIG. 10 illustrates an example error correction system that includes multiple decoders, in accordance with certain embodiments of the present disclosure.

FIG. 11 illustrates an example computing device in accordance with an embodiment of the disclosure.

### DETAILED DESCRIPTION

Data errors may be introduced into data after the data has been stored in memory for a period of time, or when data is being transmitted through a wired or wireless channel. In some cases, data bits stored in a memory or transmitted through a communication channel can be encoded to generate error correction codes (e.g., parity bits) that are added to the original data when being stored or transmitted. In an example implementation, data can be stored with error correction codes in a flash memory (e.g., NAND flash memory) such as, for example, a tri-level coding (TLC) flash memory, a quad-level coding (QLC) memory, a penta-level coding (PLC) memory, or a multi-level coding (MLC) flash memory. The error correction codes along with the data stored in the memory can be provided on to a decoder for purposes of identifying the original data bits that were provided to generate the error correction codes. As a part of this process, the decoder may use one or more error decoding algorithms to detect and correct erroneous data bits.

One example of an error correction code is a low-density parity-check code (LDPC). Different decoding algorithms can be used by a LDPC decoder to perform error correction. For example, in most of solid-state-drive (SSD) products, a bit-flipping (BF) algorithm is used to handle the majority of decoding traffic on read path. The high throughput requirement is usually obtained by using this simple but very fast decoding algorithm. A min-sum hard (MSH) decoding algorithm can also be used, for example, to decode errors that the BF algorithm fail to decode.

In some case, a decoder (e.g., LDPC decoder) may fail to successfully decode a codeword once a certain number of failed bits are encountered based on an error correction capability of the decoder. Generally, checksum can be used to predict failed bit count (FBC) when the FBC is in a certain range. However, when the FBC is above that range, the checksum starts to saturate to a certain value and can no longer be used to predict the FBC accurately. However, it is often desirable to estimate the FBC when the FBC is above the range indicating a high number of failed bits. For example, some media management algorithms may rely on an accurate FBC estimation upon saturation of checksum, e.g., to estimate an optimal read threshold voltage on read retries when the decoder fails to decode. However, when checksum of any of the previous reads saturates, this algorithm may not work well, because the checksum may no longer provide any meaningful information about the underlying FBC.

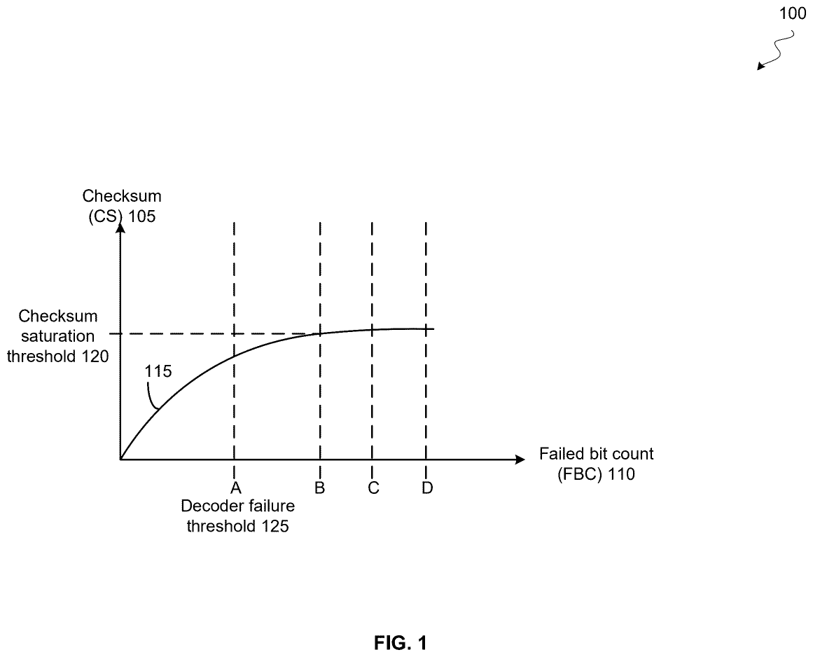

FIG. 1 illustrates an example graph 100 between a checksum (CS) 105 and an FBC 110 for a typical LDPC decoder.

In FIG. 1, curve 115 shows the correlation between CS 105 on the y-axis and FBC 110 on the x-axis. As shown by the curve 115, the checksum increases as the FBC increases initially, but starts to saturate when the FBC reaches the value A. For example, the value A may represent a decoder failure threshold 125 based on a LDPC decoder correction capability. Below the value A, the decoder can successfully decode a noisy codeword, and the checksum may follow the FBC. Beyond the value A, curve 115 starts to flatten, and the correlation between the checksum and the FBC may diminish. In some cases, checksum 105 may still be used to predict FBC 110 between the value A and a value B. However, beyond the value B (e.g., for values C and D of FBC), curve 115 flattens and the checksum may not be used to accurately predict the FBC. Thus, the checksum saturates upon crossing a checksum saturation threshold 120, and may no longer be used to predict FBC 110 accurately beyond that checksum saturation threshold 120.

Some media management algorithms may need an accurate FBC estimation at high checksum values beyond the checksum saturation point. For example, some threshold voltage estimation algorithms may use checksum to estimate an optimal read threshold voltage on read retries when the decoder fails to decode. However, when the checksum of the previous reads saturates, this algorithm may not work well, because the checksum does not provide any meaningful information about the underlying FBC. Thus, it is desirable to estimate FBC more accurately when the decoder fails and the checksum saturates.

Techniques described herein can provide methods to estimate FBC when the checksum saturates and FBC is high (e.g., beyond the value B of FBC 110). For example, when an initial checksum of a codeword exceeds a checksum saturation threshold based on the error correction capability of the error decoder, an FBC of the codeword may be estimated based on a dataset that contains correlations between decoding information and a set of FBCs (e.g., FBCs A, B, C and D). The number of errors corresponding to each FBC value may be injected into a training codeword, and an error decoder may be used to perform multiple decoding iterations for each FBC value. Decoding information can be recorded in the dataset for each decoding iteration for each FBC value. The decoding information may include, for each decoding iteration performed on the training codeword, a total number of bits flipped by the error decoder from an initial decoding iteration, and/or a checksum computed for each decoding iteration performed on the training codeword.

In the description provided herein, some specific details are set forth for the purposes of explanation and to provide a thorough understanding of certain embodiments. However, it will be apparent that various embodiments may be practiced without these specific details. Hence, the figures and description are not intended to be restrictive. Certain words and phrases are used herein based on convenience and such words and phrases should be interpreted in various forms and equivalencies by persons of ordinary skill in the art. For example, the word “bit” as used herein represents a binary value (either a “1” or a “0”) that can be stored in a memory.

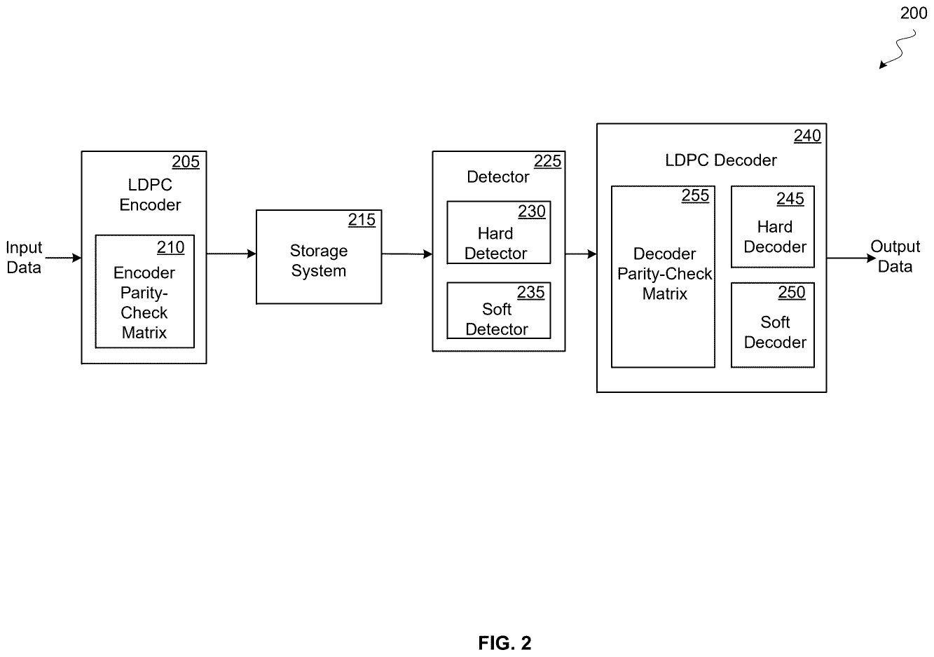

FIG. 2 illustrates a block diagram of an example error correction system 200 that can be used to perform error decoding and correction. In various embodiments, certain components of the error correction system 200 may be implemented using a variety of techniques including an application-specific integrated circuit (ASIC), a field-programmable gate array (FPGA), and/or a general-purpose processor (e.g., an Advanced RISC Machine (ARM) core).

The example error correction system 200 includes an LDPC encoder 205 that encodes input data (e.g., by adding parity bits) suitable for storing in a storage system 215. Encoding the input data enables the use of error correction procedures for correcting bit errors that may occur during operations such as, for example, writing the data into the storage system 215, reading the stored data from the storage system 215. Storage system 215 can be, or can include, for example, a solid-state drive (SSD), a storage card, a Universal Standard Bus (USB) drive, and/other storage components that are implemented using flash memories (e.g., NAND flash memories). It should be understood that various aspects of the disclosure that are described herein with respect to NAND flash memories are equally applicable to various other types of memories and to various types of communication links as well.

In an example implementation, the data and parity bits produced by the LDPC encoder 205 can be stored in memory cells in a multi-level flash memory of the storage system 215. An array of multi-level flash memories can be configured to include multiple memory blocks. Each memory block may include multiple pages. For example, a set of memory cells having a word line that is coupled in common to each of the memory cells can be configured as a page that can be read and written (or programmed) concurrently.

More specifically, a multi-level flash memory can be a type of NAND flash memory containing an array of cells each of which can be used to store multiple bits of data. For example, a tri-level cell (TLC) flash memory can store three bits of data per cell. Each of the three bits of data can be either in a programmed state (logic 0) or in an erased stated (logic 1), thereby allowing for storage of any of eight possible logic bit combinations in each cell. Each cell can be configured to store three bits of data by placing one of eight charge levels in a charge trap layer of a cell. Thus, for example, a cell may be configured to store a 000 logic bit combination by placing a first amount of charge in the cell, a cell may be configured to store a 110 logic bit combination by placing a second amount of charge in the cell, and so on. More generally, a N-bit multi-level cell can have 2^{N} logic states or charge levels representing the different possible combinations of N bits.

Data bit errors may be introduced during storage of the data bits in the multi-level flash memory and/or when writing/reading the data bits in/out of the multi-level flash memory. The data bit errors may be introduced because of various factors such as, for example, hardware defects in the flash memory, aging of the flash memory, interference by adjacent pages, software bugs, and/or read/write timing issues, read/write thresholds, etc.

The detector 225 is configured to read the data bits stored in the storage system 215. In an example implementation, the detector 225 includes a hard detector 230 and a soft detector 235. The hard detector 230 carries out detection based on voltage thresholds that provide an indication whether a detected bit is either a one or a zero. The input data bits provided to the detector 225 from the storage system 215 can have deficiencies such as, for example, bit errors. Consequently, the output produced by the hard detector 230 can contain hard errors where one or more bits have been detected inaccurately (a logic 1 read as a logic 0, or vice-versa). The soft detector 235 operates upon the input data and produces an output that is based on statistical probabilities and provides a quantitative indication of a likelihood that a detected bit is either a logic 1 or a logic 0. The statistical probabilities can be characterized by log likelihood ratio (LLR) values. A LLR that is less than 0 indicates that the bit is likely a “1”; and a LLR that is greater than 0 indicates the bit is likely a “0.” The larger the magnitude of the LLR, the more likely that the bit is the designated bit value.

The output of the detector 225 is coupled into the LDPC decoder 240. In an example implementation, the LDPC decoder 240 uses a decoder parity-check matrix 255 during decoding of the data bits. The decoder parity-check matrix 255 corresponds to the encoder parity-check matrix 210, and vice-versa. In the illustrated example, the hard detector bits provided by the detector 225 may be decoded by a hard decoder 245. The soft detector bits and the statistical probability information provided by the detector 225 may be decoded by the soft decoder 250 by use of LLR values.

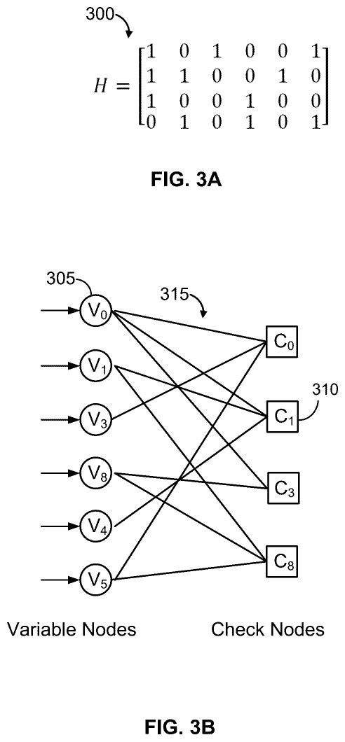

FIG. 3A illustrates an example parity-check matrix H 300 and FIG. 3B illustrates an example bipartite graph corresponding to the parity-check matrix 300, in accordance with certain embodiments of the present disclosure. In this example, the parity-check matrix 300 has six column vectors and four row vectors. In practice, parity-check matrices tend to be much larger. Network 315 forms a bipartite graph representing the parity-check matrix 300. Various type of bipartite graphs are possible, including, for example, a Tanner graph.

Generally, the variable nodes in the network 315 correspond to the column vectors in the parity-check matrix 300. The check nodes in the network 315 correspond to the row vectors of the parity-check matrix 300. The interconnections between the nodes are determined by the values of the parity-check matrix 300. Specifically, a “1” indicates that the CN and VN at the corresponding row and column position have a connection. A “0” indicates there is no connection. For example, the “1” in the leftmost column vector and the second row vector from the top in the parity-check matrix 300 corresponds to the connection between a VN 305 and a CN 310 in FIG. 3B. Collectively, the check nodes represent a syndrome computed through applying the parity-check equations represented by the parity-check matrix 300 to the received codeword. A syndrome weight (also known as a checksum) can be computed by summing together the bit-values of all the check nodes.

A message passing algorithm can be used to decode LDPC codes. Several variations of the message passing algorithm exist in the art, such as min-sum (MS) algorithm, sum-product algorithm (SPA) or the like. Message passing uses a network of variable nodes and check nodes, as shown in FIG. 3B. The connections between variable nodes and check nodes are described by and correspond to the values of the parity-check matrix 300, as shown in FIG. 3A. The content of a message passed from a variable node to a check node or vice versa depends on the message passing algorithm used.

A hard decision message passing algorithm may be performed in some instances. In a first step, each of the variable nodes sends a message to one or more check nodes that are connected to it. In this case, the message is a value that each of the variable nodes believes to be its correct value. The values of the variable nodes may be initialized according to the received codeword.

In the second step, each of the check nodes calculates a response to send to the variable nodes that are connected to it using the information that it previously received from the variable nodes. This step can be referred to as the check node update (CNU). The response message corresponds to a value that the check node believes that the variable node should have based on the information received from the other variable nodes connected to that check node. This response is calculated using the parity-check equations which force the values of all the variable nodes that are connected to a particular check node to sum up to zero (modulo 2).

At this point, if all the equations at all the check nodes are satisfied, meaning the value of each check node is zero, then the resulting checksum is also zero, so the decoding algorithm declares that a correct codeword is found and decoding terminates. If a correct codeword is not found (e.g., the value of any check node is one), the iterations continue with another update from the variable nodes using the messages that they received from the check nodes to decide if the bit at their position should be a zero or a one, e.g., using a majority voting rule in which the value of a variable node is set to the value of a majority of the check nodes connected to the variable node. The variable nodes then send this hard decision message to the check nodes that are connected to them. The iterations continue until a correct codeword is found, a certain number of iterations are performed depending on the syndrome of the codeword (e.g., of the decoded codeword), or a maximum number of iterations are performed without finding a correct codeword. It should be noted that a soft-decision decoder works similarly, however, each of the messages that are passed among check nodes and variable nodes can also include reliability information for each bit.

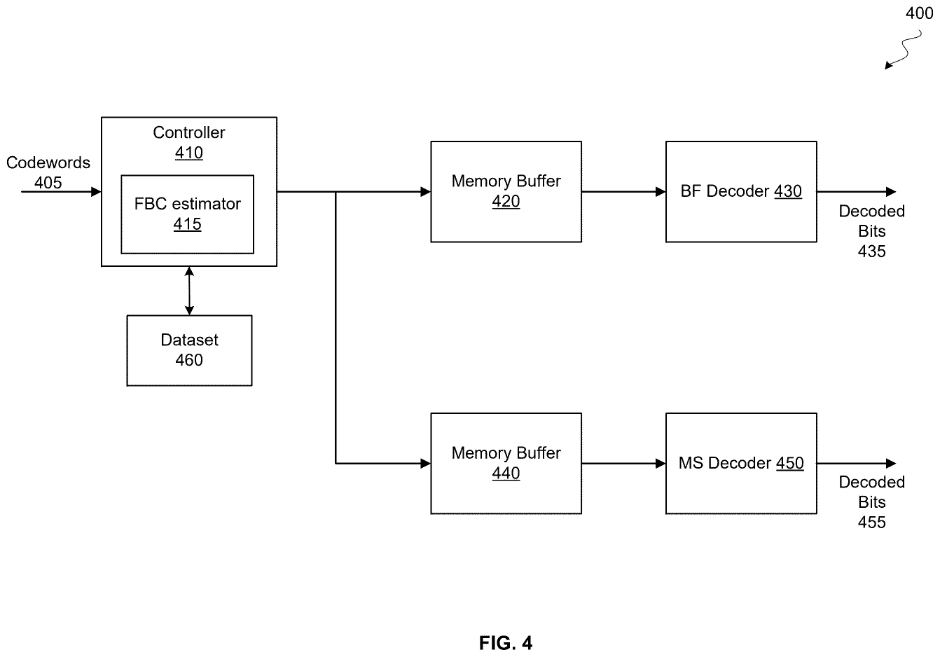

FIG. 4 illustrates an example error correction system 400 that can be used for FBC estimation, in accordance with certain embodiments of the present disclosure. The error correction system 400 can be included in a memory device, such as an SSD. In turn, the error correction system 400 includes a controller 410 comprising an FBC estimator 415, a memory buffer 420 corresponding to a BF decoder 430, and a memory buffer 440 corresponding to an MS decoder 450. The controller 410 can determine which of the two decoders 430 and 450 are to be used to decode different codewords 405 based on an estimate of the number of raw bit-errors for each of the codewords. The bit-errors can be due to noise and, accordingly, the codewords 405 can include noisy codewords. The BF decoder 430 outputs decoded bits 435 corresponding to one or more of the codewords 405, where the decoded bits 435 remove some or all of the noise (e.g., correct the error bits). Similarly, the MS decoder 450 outputs decoded bits 455 corresponding to remaining one or more of the codewords 405, where the decoded bits 455 remove some or all of the noise (e.g., correct the error bits).

If the controller 410 determines that a codeword has a severe bit error rate, a decoding failure is likely with the two decoders 430 and 450. In such instances, and assuming that the only decoders in the error correction system 400 are the decoders 430 and 450, the controller 410 may skip decoding altogether to, instead, output an error message. Otherwise, the codeword can be dispatched to the BF decoder 430 when the controller 410 determines that the bit-error rate falls within the error correction capability of the BF decoder 430. Alternatively, the codeword can be dispatched to the MS decoder 450 when the controller 410 determines that the bit-error rate is outside the error correction capability of the BF decoder 430 but within the error correction capability of the MS decoder 450. Dispatching the codeword includes storing the codeword into one of the memory buffers 420 or 440 depending on the controller's 410 determination. The memory buffers 420 and 440 are used because, in certain situations, the decoding latency is slower than the data read rate of a host reading the codewords 405.

Accordingly, over time, the codewords 405 are stored in different input queues for the BF decoder 430 and the MS decoder 450. For typical SSD usage, it is expected that most traffic would go to the BF decoder 430. Hence, improving the BF decoder can have a significant impact on the overall error correction performance. Although FIG. 4 illustrates only one low latency and high throughput decoder (BF decoder 430) and one high error correction capability decoder (MS decoder 450), a different number of decoders can be used. For instance, a second BF decoder can be also used and can have the same or a different configuration than the BF decoder 430.

In an example, the BF decoder 430 may process a fixed number “Wi” of variable nodes in one clock-cycle. In other words, for each of the “Wi” variable nodes to be processed in this cycle, the BF decoder 430 counts the number of neighboring check-nodes that are unsatisfied. As used herein, the term “neighboring” means directly connected via a single graph edge. Accordingly, neighboring check nodes for a given variable node are those check nodes which are directly connected to the variable node. However, in some implementations, a neighboring check node can be a check node that is farther away (e.g., connected through a path length of two).

The count of neighboring, unsatisfied check nodes is used to compute a numerical value of a flipping energy for the variable node. As described below, the flipping energy for at least some variable nodes can be computed taking into further account the total number of neighboring satisfied but unreliable check nodes. Once the flipping energy for a variable node has been computed, the BF decoder 430 compares this number to a flipping threshold. If the flipping energy is larger than the flipping threshold, the BF decoder 430 flips the current bit-value of the variable node. As an example, the flipping energy for the ith bit can be calculated using the following equation:

$$E ( i ) = \sum \{ {∀}_{j} w / H ( i , j ) = 1 \} s\_old ( j ) + ( dec\_prev ( i ) != chn ( i ) ) ,$$

where s_old is the syndrome, and dec_prev is the current value of the variable node, and chn(i) is the channel value. In some examples, the algorithm described by the above equation for calculating the flipping energy is called a basic BF algorithm due to the single bit/node flipping nature of the algorithm.

The processing of all the variable nodes of the LDPC codes for a single iteration may occur over multiple clock cycles. In examples featuring circulant submatrices, each clock cycle may involve computing flipping energies for variable nodes associated with one or more circulant submatrices and updating the bit-values of those variable nodes accordingly. In general, all circulant submatrices are processed over the course of a single iteration. At the end of the iteration, the BF decoder 430 updates the bit-values of the check nodes using the updated bit-values of the variable nodes, and the BF decoder 430 may proceed to the next iteration if any of the check nodes remain unsatisfied or a maximum allowable number of iterations has not yet been reached.

When irregular LDPC codes are used to improve the correction performance of the MS decoder 450, the number of non-zero elements in each column (e.g., column weight or column degree) can vary across different columns. A good irregular code for the MS decoder 450 may typically lead to poor correction performance of the BF decoder 430. For example, in some cases, the BF decoder 430 may not work well with low degree nodes (e.g., degree-3 variable nodes), since the information available to make a flipping decision is limited by the number of non-zero elements.

The BF decoder 430 is generally able to correct most of the errors in a first iteration. In some cases, a small set of check nodes (sometimes called a trapping set) may remain unsatisfied even after multiple iterations of error corrections have been attempted by the BF decoder 430. For example, some of the check nodes may keep oscillating or changing their bit values in each iteration. Each trapping set may represent an error pattern and can be a specific combination of variable nodes that, if the bit-values of all the variable nodes in the trapping set are in error, then the decoder will be unable to correct those errors.

A decoder with a higher error correction capability will have fewer trapping sets and/or larger-sized trapping sets compared to a decoder with a lower error correction capability. For example, conventional BF decoders have a greater number of trapping sets compared to MS decoders, resulting in code failures at lower failed-bit counts. As discussed above, one of the advantages of a BF decoder is its decoding speed. Using a decoder with higher error correction capability may not always be feasible due to additional decoding latency. BF decoders that use more complex message passing techniques (e.g., 2-bit wide messages, where one bit is used to signal node reliability) are another option but tend to be costly due to increased implementation complexity (e.g., higher logic-gate count) and increased power consumption.

In some aspects of the disclosure, the controller 410 may obtain the codeword 405 from performing a read operation on a memory, e.g., the storage system 215. The controller 410 may perform error decoding on the codeword 405 with an error decoder (e.g., the LDPC decoder 240, BF decoder 430, or the MS decoder 450) to generate an initial checksum. The controller 410 may determine that the initial checksum of the codeword 405 exceeds a checksum saturation threshold corresponding to an error correction capability of the error decoder. The controller 410 may use the FBC estimator 415 to determine a FBC estimation of the codeword 405 based on a dataset 460 containing correlations between decoding information and a set of FBCs.

The FBC estimator 415 may be configured to estimate an FBC of the codeword 405 by comparing the initial checksum with a checksum saturation threshold corresponding to an error correction capability of the error decoder. When the initial checksum is at or below the checksum saturation threshold, the FBC estimator 415 may estimate the FBC using the initial checksum. When the initial checksum of the codeword exceeds the checksum saturation threshold, the FBC estimator 415 may determine a FBC estimation of the codeword 405 based on the dataset 460 containing correlations between decoding information and a set of FBCs.

In some aspects of the disclosure, the dataset 460 can be generated by performing a plurality of decoding iterations to decode a noisy codeword using the error decoder. For example, for each FBC in the set of FBCs, a FBC number of errors may be injected into a training codeword, and a plurality of decoding iterations may be performed on the training codeword using the error decoder. Decoding information for each decoding iteration may be recorded in the dataset 460 for each FBC. The FBC estimator 415 may estimate the FBC by identifying a decoding iteration from the plurality of decoding iterations at which the decoding information saturates, and use the identified decoding iteration of the codeword to determine the FBC estimation of the codeword. In some embodiments, the FBC estimator 415 may provide the decoding information of the codeword to a neural network model trained with the dataset to obtain the FBC estimation. The controller 410 may perform a corrective action on the memory based on the FBC estimation.

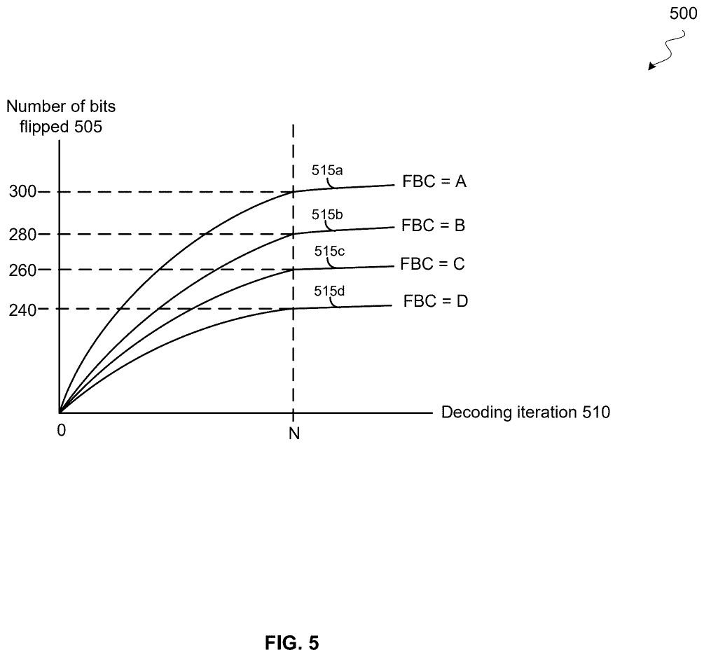

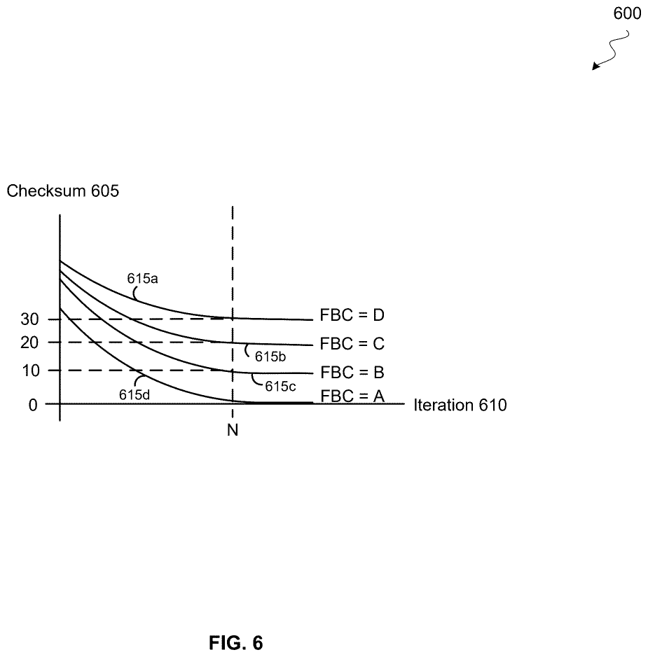

In some implementations, the decoding information may include, for each decoding iteration performed on the training codeword, a total number of bits flipped by the error decoder from an initial decoding iteration and/or a checksum computed for the decoding iteration. For example, a total number of bits flipped by the error decoder from an initial decoding iteration may be recorded the dataset 460 for each decoding iteration performed on the training codeword. This is described in detail with reference to FIG. 5. In some implementations, a checksum computed for each decoding iteration performed on the training codeword may be recorded in the dataset 460. This is described in detail with reference to FIG. 6.

In some examples, the controller 410 may perform a second memory read operation to obtain a second codeword in the codewords 405, and perform error decoding on the second codeword with the error decoder to generate a second initial checksum. The controller 410 may determine that the second initial checksum of the second codeword is at or below the checksum saturation threshold, and estimate a FBC of the second codeword using the second initial checksum. For example, if the second initial checksum is below the checksum saturation threshold 120, the controller 410 may use the second initial checksum to estimate the FBC of the second codeword.

FIG. 5 illustrates an example graph 500 showing correlations between a total number of bits flipped 505 and a set of FBCs for a plurality of decoding iterations 510, in some aspects of the disclosure.

The set of FBCs may include FBCs A, B, C, and D. For each of the FBCs A, B, C, and D, the example graph 500 shows the total number of bits flipped 505 for the plurality of decoding iterations 510 from an initial decoding iteration 510, e.g., 0. In FIG. 5, a curve 515a shows a correlation between the total number of bits flipped 505 and FBC A from the initial decoding iteration 510, a curve 515b shows a correlation between the total number of bits flipped 505 and FBC B from the initial decoding iteration 510, a curve 515c shows a correlation between the total number of bits flipped 505 and FBC C from the initial decoding iteration 510, and a curve 515d shows a correlation between the total number of bits flipped 505 and FBC D from the initial decoding iteration 510. As described previously, the correlations between the total number of bits flipped 505 and the set of FBCs as shown by the curves 515a, 515b, 515c, and 515d may be provided by the decoding information recorded in the dataset by performing the decoding iterations 510 to decode a training codeword having a number of errors corresponding to FBC A, B, C, and D, respectively, using the error decoder.

In some examples, FBC A may include 300 bits, FBC B may include 400 bits, FBC C may include 450 bits, and FBC D may include 500 bits, and the plurality of decoding iterations may include 8 iterations. As shown in FIG. 5, the total number of bits flipped 505 increases with each decoding iteration for each of the FBCs A, B, C, and D, but starts to saturate after an N^{th} decoding iteration as the curves 515a, 515b, 515c, and 515d start to flatten, e.g., N can be 4. For example, the total number of bits flipped 505 starts to saturate around 300 for FBC A, around 280 for FBC B, around 260 for FBC C, and around 240 for FBC D. In some aspects of the disclosure, a decoding iteration at which the decoding information saturates (e.g., 4^{th} decoding iteration in this example) can be used to determine the FBC estimation. For example, a look-up table having all the values of the total number of bits flipped 505 recorded at the N^{th} iteration can be used for the FBC estimation. In another example, a deep neural network model (DNN) can be used to obtain the FBC estimation based on different values of the correlations for the plurality of decoding iterations.

FIG. 6 illustrates an example graph 600 showing correlations between a checksum 605 and a set of FBCs for a plurality of decoding iterations 610, in some aspects of the disclosure.

The set of FBCs may include FBCs A, B, C, and D. For each of the FBCs A, B, C, and D, the example graph 600 shows the checksum 605 for the plurality of decoding iterations 610. In FIG. 6, a curve 615a shows a correlation between the checksum 605 and FBC A for the plurality of decoding iterations 610, a curve 615b shows a correlation between the checksum 605 and FBC B for the plurality of decoding iterations 610, a curve 615c shows a correlation between the checksum 605 and FBC C for the plurality of decoding iterations 610, and a curve 615d shows a correlation between the checksum 605 and FBC D for the plurality of decoding iterations 610. As described previously, the correlations between the checksum 605 and the set of FBCs as shown by the curves 615a, 615b, 615c, and 615d may be provided by the decoding information recorded in the dataset by performing the decoding iterations 610 to decode a training codeword having a number of errors corresponding to FBC A, B, C, and D, respectively, using the error decoder.

In some examples, FBC A may include 300 bits, FBC B may include 400 bits, FBC C may include 450 bits, and FBC D may include 500 bits, and the plurality of decoding iterations may include 8 iterations. As shown in FIG. 6, the checksum 605 decreases with each decoding iteration for each of the FBCs A, B, C, and D, but starts to saturate after an N^{th} decoding iteration as the curves 615a, 615b, 615c, and 615d start to flatten, e.g., N can be 4. For example, the checksum 605 starts to saturate around 0 for FBC A, around 10 for FBC B, around 20 for FBC C, and around 30 for FBC D. In some embodiments, a decoding iteration at which the decoding information saturates (e.g., 4th decoding iteration in this example) can be used to determine the FBC estimation. For example, a look-up table having all the values of the checksum 605 recorded at the N^{th} iteration can be used for the FBC estimation. In another example, a DNN can be used to obtain the FBC estimation based on different values of the correlations for the plurality of decoding iterations.

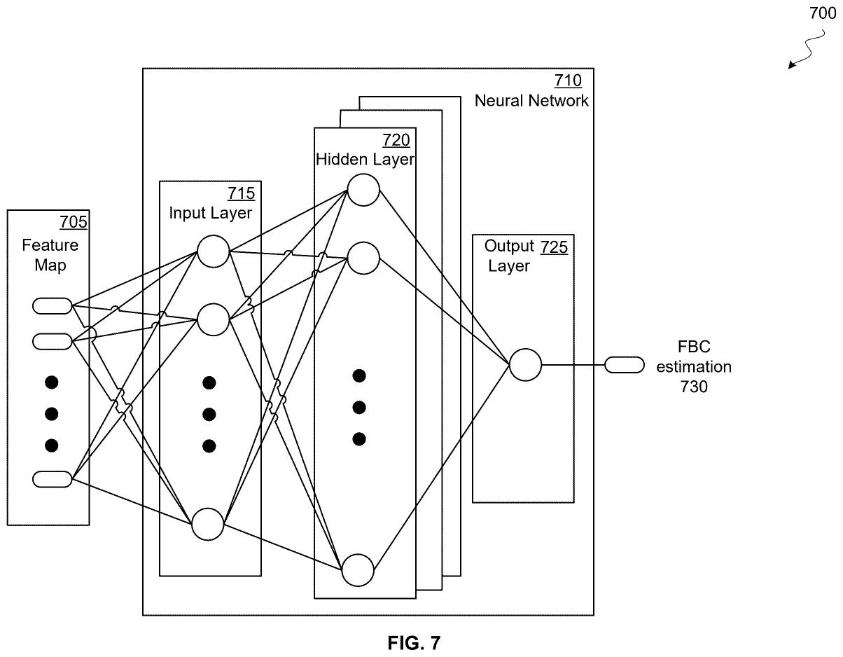

In some implementations, a function or several functions of the entire curves for the graph 500 (e.g., curves 515a-515d) and the graph 600 (e.g., curves 615a-615d) can be used as features for the FBC estimation. Different machine learning frameworks may be used to perform FBC estimation based on the features. For example, a DNN can be used to obtain FBC estimation based on different values of the correlations between the total number of bits flipped 505 and/or the checksum 605 with the FBCs A, B, C, and D for the plurality of decoding iterations using the dataset. This is further described with reference to FIG. 7.

FIG. 7 illustrates an example neural network 710 configured as an FBC estimator in accordance with an embodiment of the disclosure. The example neural network 710 can be any of various types of deep neural networks that include one or more hidden layers. The activation function for each layer can be a rectified linear unit (ReLU) function.

By way of example, feature maps 705 each associated with one or more function or several functions of the curves 515a-515d described with reference to FIG. 5, and curves 615a-615d described with reference to FIG. 6 can be used. In turn, the neural network 710 outputs an FBC estimation 730. As illustrated, the neural network 710 includes multiple layers. Feature maps 705 are connected to input nodes in an input layer 715 of the neural network. The FBC estimation 730 is generated from an output node of an output layer 725. One or more hidden layers 720 of the neural network 710 exist between the input layer 715 and the output layer 725. The neural network 710 is pre-trained to process the feature maps 705 through the different layers 715, 720, and 725 in order to output the FBC estimation 730.

In some embodiments, the neural network 710 is a multi-layer neural network that represents a network of interconnected nodes, such as an artificial deep neural network, where knowledge about the nodes (e.g., information about specific features represented by the nodes) is shared across layers and knowledge specific to each layer is also retained. Each node represents a piece of information. Knowledge can be exchanged between nodes through node-to-node interconnections. Input to the neural network 710 activates a set of nodes. In turn, this set of nodes activates other nodes, thereby propagating knowledge about the input. This activation process is repeated across other nodes until nodes in an output layer are selected and activated.

As illustrated, the neural network 710 includes a hierarchy of layers representing a hierarchy of nodes interconnected in a feed-forward way. The input layer 715, which exists at the lowest hierarchy level, includes a set of nodes that are referred to herein as input nodes. When the inputs are provided to the neural network 710, each of the input nodes of the input layer 715 is connected to each feature of the feature maps. Each of the connections has a weight. These weights are one set of parameters that are derived from the training of the neural network 710. The input nodes transform the features by applying an activation function to the weighted features. The information derived from the transformation are passed to the nodes at a higher level of the hierarchy.

The output layer 725, which exists at the highest hierarchy level, includes an output node that outputs the FBC estimation 730. The hidden layer(s) 720 exists between the input layer 715 and the output layer 725. The hidden layer(s) 720 includes “M” number of hidden layers, where “M” is an integer greater than or equal to one. In turn, each of the hidden layers also includes a set of nodes that are referred to herein as hidden nodes. In an example implementation, neural network model 710 may include two hidden layers, and each layer can be a fully connected layer.

At the lowest level of the hidden layer(s) 720, hidden nodes of that layer are interconnected to the input nodes. At the highest level of the hidden layer(s) 720, hidden nodes of that level are interconnected to the output node. The input nodes are not directly interconnected to the output node(s). If multiple hidden layers exist, the input nodes are interconnected to hidden nodes of the lowest hidden layer. In turn, these hidden nodes are interconnected to the hidden nodes of the next hidden layer and so on and so forth. An interconnection represents a piece of information learned about the two interconnected nodes. The interconnection has a numeric weight that can be tuned (e.g., based on a training dataset), rendering the neural network 710 adaptive to inputs and capable of learning.

Generally, the hidden layer(s) 720 allows knowledge about the input nodes of the input layer 715 to be shared among the output nodes of the output layer 725. To do so, a transformation ƒ is applied to the input nodes through the hidden layer 720. In an example, the transformation ƒ is non-linear. Different non-linear transformations ƒ are available including, for instance, a rectifier function ƒ(x)=max(0, x). In an example, a particular non-linear transformation ƒ is selected based on cross-validation. For example, given known example pairs (x, y), where x∈X and y∈Y, a function ƒ:X→Y is selected when such a function results in the best matches.

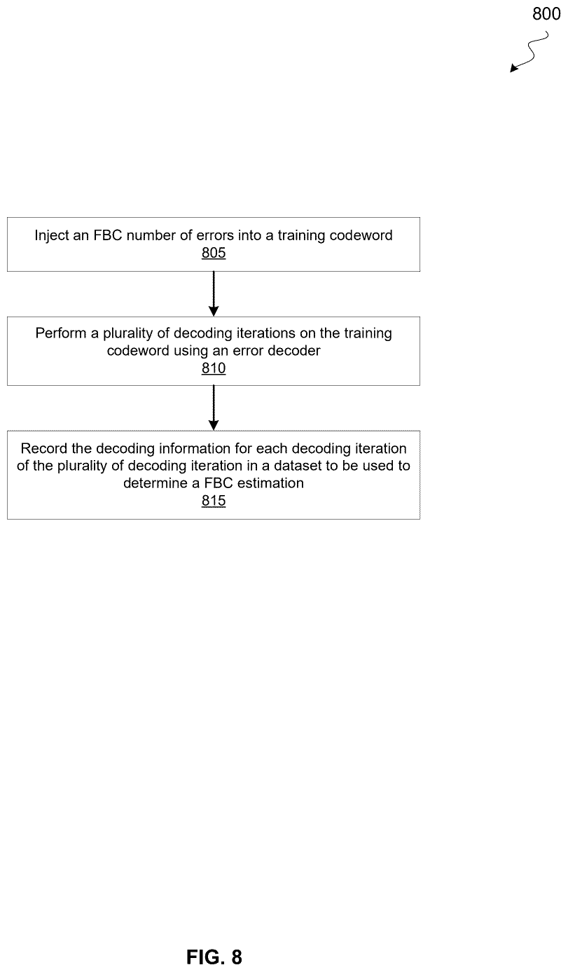

FIG. 8 illustrates a flow diagram of an example of a process 800 for generating a dataset to be used for FBC estimation in certain aspects of the disclosure. Process 800 can be implemented as software (e.g., firmware) executed by one or more processors, or a combination of software and hardware circuitry. In some implementations, the process may be performed by the controller 410.

Process 800 may begin at block 805 by injecting an FBC number of errors into a training codeword. For example, the controller 410 may receive the training codeword as part of the codewords 405, and inject a number of errors corresponding to FBC A in FIG. 5 in the training codeword.

At block 810, a plurality of decoding iterations may be performed on the training codeword using an error decoder. For example, the controller 410 may perform a plurality of decoding iterations using the LDPC decoder 240. As described with reference to FIG. 5, the controller 410 may perform the decoding iterations 510.

At block 815, decoding information for each decoding iteration of the plurality of decoding iterations can be recorded in the dataset to determine a FBC estimation. The controller 410 may record the decoding information for each decoding iteration in the dataset 460. As described with reference to FIG. 5, the controller 410 may record the total number of bits flipped 505 as part of the decoding information for each decoding iteration 510 in the dataset 460. As described with reference to FIG. 6, the controller 410 may also record the checksum 605 as part of the decoding information for each decoding iteration 610 in the dataset 460. In some examples, the decoding iteration 510 and the decoding iteration 610 are the same, and the controller 410 records both the total number of bits flipped 505 and the checksum 605 for each decoding iteration in the dataset 460.

Process 800 may be repeated for each FBC in a set of FBCs, e.g., FBCs A, B, C, and D. Thus, as described with reference to FIG. 5 and FIG. 6, the curves 515a-515d, and the curves 615a-615d may be obtained, which can be used by the FBC estimator 415 to determine the FBC estimation. In some examples, the dataset 460 may be used to train the neural network model described with reference to FIG. 7, which can be used to determine the FBC estimation.

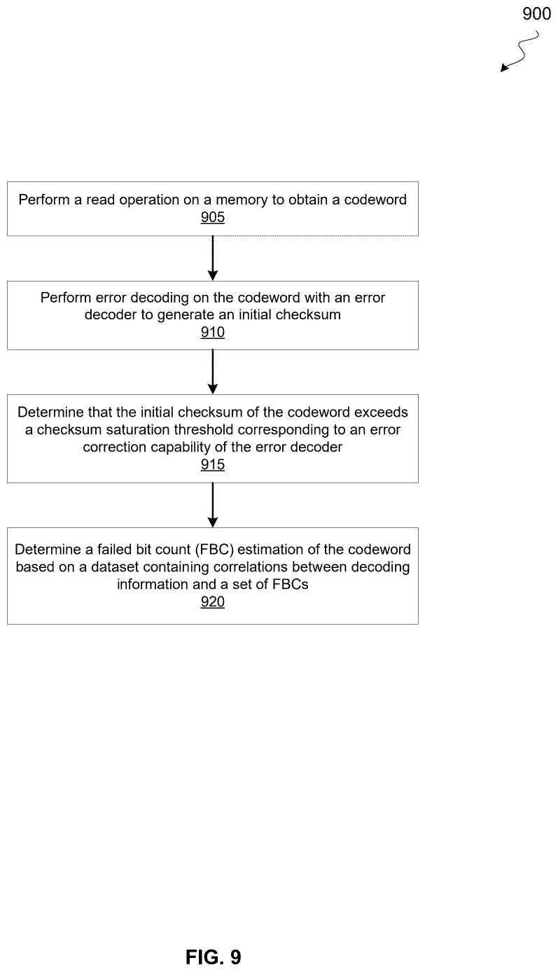

FIG. 9 illustrates a flow diagram of an example of a process 900 for determining an FBC estimation, in certain aspects of the disclosure. Process 900 can be implemented as software (e.g., firmware) executed by one or more processors, or a combination of software and hardware circuitry. In some implementations, the process may be performed by the controller 410 by executing code stored in a non-transitory computer readable medium.

Process 900 may begin at block 905 by performing a read operation on a memory to obtain a codeword. The controller 410 may obtain the codeword 405 from performing a read operation on a memory, e.g., the storage system 215. As an example, the storage system 215 may include a solid state drive (SSD) operable to store data in a NAND flash memory.

At block 910, error decoding may be performed on the codeword with an error decoder to generate an initial checksum. The controller 410 may perform error decoding on the codeword 405 using the LDPC decoder 240 to generate an initial checksum. The controller 410 may compare the initial checksum with a checksum saturation threshold corresponding to an error correction capability of the of the LDPC decoder 240. For example, the checksum saturation threshold may correspond to the checksum saturation threshold 120 shown in FIG. 1.

At block 915, it may be determined that the initial checksum of the codeword exceeds a checksum saturation threshold corresponding to an error correction capability of the error decoder. The controller 410 may determine that the initial checksum of the codeword exceeds checksum saturation threshold 120 corresponding to an error correction capability of the LDPC decoder 240.

At block 920, a FBC estimation of the codeword may be determined based on a dataset containing correlations between decoding information and a set of FBCs. The controller 410 may use the FBC estimator 415 to determine the FBC estimation based on the dataset 460. For example, the dataset 460 may be obtained using the process 800 described with reference to FIG. 8. In some examples, the neural network 710 may be used to provide the FBC estimation 730 based on the feature maps 705 derived from the curves 515a-515d and/or 615a-615d. The controller 410 may perform a corrective action on the memory based on the FBC estimation.

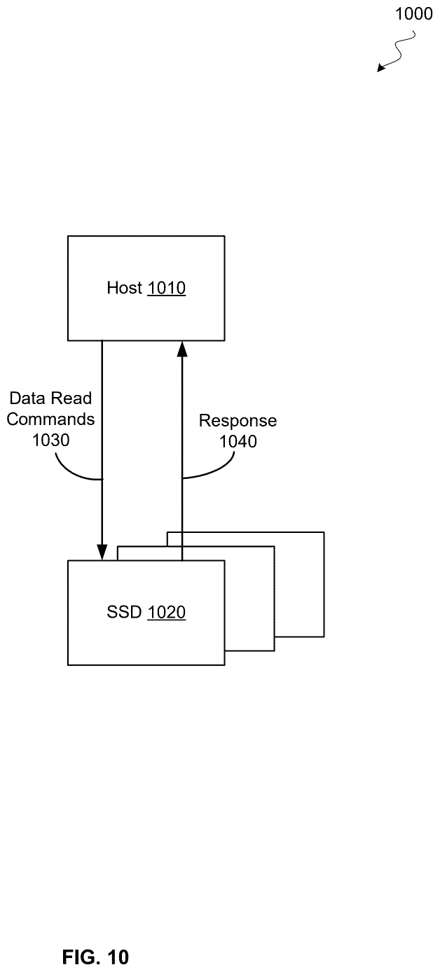

FIG. 10 illustrates an example architecture of a computer system 1000, in accordance with certain embodiments of the present disclosure. In an example, the computer system 1000 includes a host 1010 and one or more solid state drives (SSDs) 1020. The host 1010 stores data on behalf of clients, e.g., the SSDs 1020. The data is stored in an SSD as codewords for ECC protection. For instance, the SSD can include an error correction system comprising one or more ECC encoders (e.g., the LDPC encoder of FIG. 2).

The host 1010 can receive a request from a client for the client's data stored in the SSDs 1020. In response, the host sends data read commands 1030 to the SSDs 1020 as applicable. Each of the SSDs 1020 processes the received data read command and sends a response 1040 to the host 1010 upon completion of the processing. The response 1040 can include the read data and/or a decoding failure. In an example, each of the SSDs includes at least one ECC decoder (e.g., one or more of the LDPC decoder of FIG. 2). Processing the data read command and sending the response 1040 includes decoding by the ECC decoder(s) the codewords stored in the SSD to output the read data and/or the decoding failure.

In an example where an SSD 1020 includes a BF decoder and one or more additional ECC decoders, the SSD may be configured to attempt an initial decoding of its stored codewords using the BF decoder. The one or more additional ECC decoders can remain inactive while the BF decoder is decoding.

If the decoding by the BF decoder is unsuccessful, the SSD may select one of the additional ECC decoders (e.g., based on a hierarchical order) for performing decoding. Thus, the one or more additional ECC decoders may act as backup decoders in the event that the BF decoder cannot fully decode a codeword. A backup decoder need not process all the codewords input to the BF decoder. Instead, in some examples, the input to a backup decoder is a subset of the input to a previously selected decoder, where the subset corresponds to codewords that the previously selected decoder failed to fully decode. Further, some of the additional ECC decoders may be operated in parallel with the BF decoder to perform parallel processing of codewords. For example, as discussed below in connection with FIG. 4, an incoming set of codewords can be distributed across a BF decoder and an MS decoder so that each decoder processes a distinct subset of codewords.

Generally, an SSD can be a storage device that stores data persistently or caches data temporarily in nonvolatile semiconductor memory and is intended for use in storage systems, servers (e.g., within datacenters), and direct-attached storage (DAS) devices. A growing number of applications need high data throughput and low transaction latency, and SSDs are used as a viable storage solution to increase performance, efficiency, and reliability. SSDs generally use NAND flash memory and deliver higher performance and consume less power than spinning hard-disk drives (HDDs). NAND Flash memory has a number of inherent issues associated with it, the two most important include a finite life expectancy as NAND Flash cells wear out during repeated writes, and a naturally occurring error rate. SSDs can be designed and manufactured according to a set of industry standards that define particular performance specifications, including latency specifications, to support heavier write workloads, more extreme environmental conditions and recovery from a higher bit error rate (BER) than a client SSD (e.g., personal computers, laptops, and tablet computers).

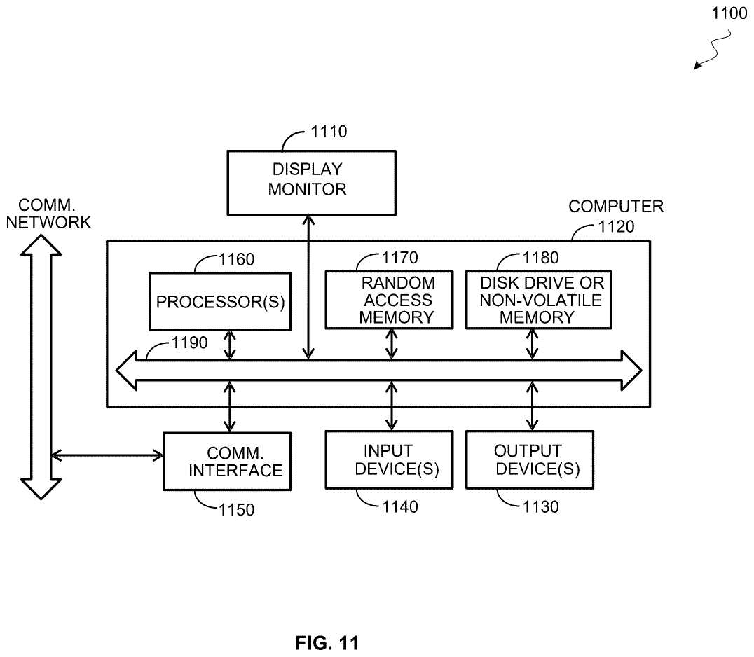

FIG. 11 illustrates a computer system 1100 usable for implementing one or more embodiments of the present disclosure. FIG. 11 is merely an example and does not limit the scope of the disclosure as recited in the claims. As shown in FIG. 11, the computer system 1100 may include a display monitor 1110, a computer 1120, a user output device 1130, a user input device 1140, a communications interface 1150, and may further include other computer hardware or accessories. In an example implementation, the computer system 1100, or select components of the computer system 1100, can apply the FBC estimation techniques disclosed herein. For example, non-volatile memory 1180 may include a flash memory. Data read from the flash memory can be subject to the error correction, and the error correction can apply the FBC estimation in accordance with the techniques disclosed herein.

The computer 1105 may include one or more processors such as, for example, the processor 1160 that is configured to communicate with a number of peripheral devices via a bus subsystem 1190. Some example peripheral devices may include the user output device 1130, the user input device 1140, and the communications interface 1150. The computer 1120 may further include a storage subsystem that includes a random-access memory (RAM) 1170 and a disk drive 1180 or other forms of non-volatile memory.

The user input device 1140 can be any of various types of devices and mechanisms for inputting information to the computer 1120 such as, for example, a keyboard, a keypad, a touch screen incorporated into the display, and audio input devices (such as voice recognition systems, microphones, and other types of audio input devices). In various embodiments, the user input device 1140 is typically embodied as a computer mouse, a trackball, a track pad, a joystick, a wireless remote, a drawing tablet, a voice command system, an eye tracking system, and the like. The user input device 1140 typically allows a user to select objects, icons, text and the like that appear on the monitor 1110 via a command such as a click of a button or the like.

The user output device 1130 can be any of various types of devices and mechanisms for outputting information from the computer 1120 such as, for example, a display (e.g., the display monitor 1110), non-visual displays such as audio output devices, etc.

The communications interface 1150 provides an interface to a communication network. The communications interface 1150 may serve as an interface for receiving data from and transmitting data to other systems. Embodiments of the communications interface 1150 typically include an Ethernet card, a modem (telephone, satellite, cable, ISDN), (asynchronous) digital subscriber line (DSL) unit, Fire Wire interface, USB interface, and the like. In an example implementation, the communications interface 1150 may be coupled to a computer network, to a Fire Wire bus, or the like. In other example implementations, the communications interfaces 1150 may be physically integrated on the motherboard of the computer 1120, and may include a software program, such as soft DSL, or the like.

In various embodiments, the computer system 1100 may also include software that enables communications over a network such as the HTTP, TCP/IP, RTP/RTSP protocols, and the like. In alternative embodiments of the present disclosure, other communications software and transfer protocols may also be used, for example IPX, UDP or the like.

The RAM 1170 and the disk drive 1180 are examples of non-transitory computer-readable media configured to store computer-executable instructions for performing operations associated with various embodiments of the present disclosure, including executable computer code, human readable code, or the like. Other types of computer-readable storage media include floppy disks, removable hard disks, optical storage media such as CD-ROMS, DVDs and bar codes, semiconductor memories such as flash memories, non-transitory read-only-memories (ROMS), battery-backed volatile memories, networked storage devices, and the like. The RAM 1170 and the disk drive 1180 may be configured to store the basic programming and data constructs that provide the functionality of the present disclosure.

Software code modules and instructions that provide the functionality of the present disclosure may be stored in the RAM 1170 and the disk drive 1180. These software modules may be executed by the processor 1160. The RAM 1170 and the disk drive 1180 may also provide a repository for storing data used in accordance with the present disclosure.

The RAM 1170 and the disk drive 1180 may include a number of memories such as a main random-access memory (RAM) for storage of instructions and data during program execution and a read-only memory (ROM) in which fixed non-transitory instructions are stored. The RAM 1170 and the disk drive 1180 may include a file storage subsystem providing persistent (non-volatile) storage for program and data files. The RAM 1170 and the disk drive 1180 may also include removable storage systems, such as removable flash memory.

The bus subsystem 1190 provides a mechanism for letting the various components and subsystems of the computer 1120 communicate with each other as intended. Although the bus subsystem 1190 is shown schematically as a single bus, alternative embodiments of the bus subsystem may utilize multiple busses.

It will be readily apparent to one of ordinary skill in the art that many other hardware and software configurations are suitable for use with the present disclosure. For example, the computer 1120 may be a desktop, portable, rack-mounted, or tablet configuration. Additionally, the computer 1120 may be a series of networked computers. In still other embodiments, the techniques described above may be implemented upon a chip or an auxiliary processing board.

Various embodiments of the present disclosure can be implemented in the form of logic in software or hardware or a combination of both. The logic may be stored in a computer-readable or machine-readable non-transitory storage medium as a set of instructions adapted to direct a processor of a computer system to perform a set of steps disclosed in embodiments of the present disclosure. The logic may form part of a computer program product adapted to direct an information-processing device to perform a set of steps disclosed in embodiments of the present disclosure. Based on the disclosure and teachings provided herein, a person of ordinary skill in the art will appreciate other ways and/or methods to implement the present disclosure.

The data structures and code described herein may be partially or fully stored on a computer-readable storage medium and/or a hardware module and/or hardware apparatus. A computer-readable storage medium includes, but is not limited to, volatile memory, non-volatile memory, and magnetic and optical storage devices, such as disk drives, magnetic tape, CDs, DVDs, or other media, now known or later developed, that are capable of storing code and/or data. Hardware modules or apparatuses described herein include, but are not limited to, ASICs, FPGAs, dedicated or shared processors, and/or other hardware modules or apparatuses now known or later developed.

The methods and processes described herein may be partially or fully embodied as code and/or data stored in a computer-readable storage medium or device, so that when a computer system reads and executes the code and/or data, the computer system performs the associated methods and processes. The methods and processes may also be partially or fully embodied in hardware modules or apparatuses, so that when the hardware modules or apparatuses are activated, they perform the associated methods and processes. The methods and processes disclosed herein may be embodied using a combination of code, data, and hardware modules or apparatuses.

The embodiments disclosed herein are not to be limited in scope by the specific embodiments described herein. Various modifications of the embodiments of the present disclosure, in addition to those described herein, will be apparent to those of ordinary skill in the art from the foregoing description and accompanying drawings. Further, although some of the embodiments of the present disclosure have been described in the context of a particular implementation in a particular environment for a particular purpose, those of ordinary skill in the art will recognize that the disclosure's usefulness is not limited thereto and that the embodiments of the present disclosure can be beneficially implemented in any number of environments for any number of purposes.

What is claimed is:

1. A method comprising:
performing a read operation on a memory to obtain a codeword;
performing error decoding on the codeword with an error decoder to generate an initial checksum;
determining that the initial checksum of the codeword exceeds a checksum saturation threshold corresponding to an error correction capability of the error decoder; and
determining a failed bit count (FBC) estimation of the codeword based on a dataset containing correlations between decoding information and a set of FBCs, wherein the dataset is obtained by:
for each FBC in the set of FBCs:
injecting the FBC number of errors into a training codeword;
performing a plurality of decoding iterations on the training codeword using the error decoder; and
recording, in the dataset, the decoding information for each decoding iteration.

2. The method of claim 1, further comprising performing a corrective action on the memory based on the FBC estimation.

3. The method of claim 1, wherein the decoding information includes, for each decoding iteration performed on the training codeword, a total number of bits flipped by the error decoder from an initial decoding iteration.

4. The method of claim 1, wherein the decoding information includes a checksum computed for each decoding iteration performed on the training codeword.

5. The method of claim 1, wherein the decoding information includes, for each decoding iteration performed on the training codeword, a total number of bits flipped by the error decoder from an initial decoding iteration and a checksum computed for the decoding iteration.

6. The method of claim 1, wherein determining the FBC estimation includes:
identifying a decoding iteration from the plurality of decoding iterations at which the decoding information saturates, and
using the identified decoding iteration of the codeword to determine the FBC estimation of the codeword.

7. The method of claim 1, wherein determining the FBC estimation includes:
providing decoding information of the codeword to a neural network model trained with the dataset to obtain the FBC estimation.

8. The method of claim 1, further comprising:
performing a second memory read operation to obtain a second codeword;
performing error decoding on the second codeword with the error decoder to generate a second initial checksum;
determining that the second initial checksum of the second codeword is at or below the checksum saturation threshold; and
estimating a FBC of the second codeword using the second initial checksum.

9. The method of claim 1, wherein the error decoder is a low-density parity check (LDPC) decoder.

10. A storage device comprising:
a controller; and
a memory coupled to the controller,
wherein the controller is configured to perform operations including:
performing a read operation on the memory to obtain a codeword;
performing error decoding on the codeword with an error decoder to generate an initial checksum;
determining that the initial checksum of the codeword exceeds a checksum saturation threshold corresponding to an error correction capability of the error decoder; and
determining a failed bit count (FBC) estimation of the codeword based on a dataset containing correlations between decoding information and a set of FBCs, wherein the dataset is obtained by:
for each FBC in the set of FBCs:
injecting the FBC number of errors into a training codeword;
performing a plurality of decoding iterations on the training codeword using the error decoder; and
recording, in the dataset, the decoding information for each decoding iteration.

11. The storage device of claim 10, wherein the operations further include performing a corrective action on the memory based on the FBC estimation.

12. The storage device of claim 10, wherein the decoding information includes, for each decoding iteration performed on the training codeword, a total number of bits flipped by the error decoder from an initial decoding iteration.

13. The storage device of claim 10, wherein the decoding information includes a checksum computed for each decoding iteration performed on the training codeword.

14. The storage device of claim 10, wherein the decoding information includes, for each decoding iteration performed on the training codeword, a total number of bits flipped by the error decoder from an initial decoding iteration and a checksum computed for the decoding iteration.

15. The storage device of claim 10, wherein determining the FBC estimation includes:
identifying a decoding iteration from the plurality of decoding iterations at which the decoding information saturates, and
using the identified decoding iteration of the codeword to determine the FBC estimation of the codeword.

16. The storage device of claim 10, wherein determining the FBC estimation includes:
providing decoding information of the codeword to a neural network model trained with the dataset to obtain the FBC estimation.

17. The storage device of claim 10, wherein the operations further include:
performing a second memory read operation to obtain a second codeword;
performing error decoding on the second codeword with the error decoder to generate a second initial checksum;
determining that the second initial checksum of the second codeword is at or below the checksum saturation threshold; and
estimating a FBC of the second codeword using the second initial checksum.

18. The storage device of claim 10, wherein the error decoder is a low-density parity check (LDPC) decoder.

19. The storage device of claim 10, wherein the memory includes NAND flash memory.

20. A non-transitory computer readable medium storing code that, when executed by a controller, causes the controller to perform operations including:
performing a read operation on a memory to obtain a codeword;
performing error decoding on the codeword with an error decoder to generate an initial checksum;
determining that the initial checksum of the codeword exceeds a checksum saturation threshold corresponding to an error correction capability of the error decoder; and
determining a failed bit count (FBC) estimation of the codeword based on a dataset containing correlations between decoding information and a set of FBCs, wherein the dataset is obtained by:
for each FBC in the set of FBCs:
injecting the FBC number of errors into a training codeword;
performing a plurality of decoding iterations on the training codeword using the error decoder; and
recording, in the dataset, the decoding information for each decoding iteration including:
a total number of bits flipped by the error decoder from an initial decoding iteration; or
a checksum computed for the corresponding decoding iteration.
